(19) United States
(12) Patent Application Publication
(10) Pub. No.: US 2008/0224521 A1
(43) Pub. Date: Sep. 18, 2008

(54) Portable Obstetrics Chair

(76) Inventor: Kathleen Topping, Nottingham (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/908,946

(22) PCT Filed: Mar. 20, 2006
(86) PCT No.: PCT/GB06/00982

§ 371 Date: Mar. 12, 2008

(30) Foreign Application Priority Data
Mar. 18, 2005 (GB) 0505566.0

(51) Int. Cl. A47C 3/20; A47C 9/02; A61G 15/00

(52) U.S. Cl. 297/338

(57) ABSTRACT

A portable chair for use by an obstetrics practitioner during delivery of a baby, comprising a seat for receiving the posterior of the practitioner, a height adjustment means for varying the height of the seat above a floor surface (such as in a delivery room or home environment), and a base unit configured to allow translation of the chair in a plurality of directions across the floor surface. The height adjustment means is adapted for lowering the height of the seat to a first 0 level at which the posterior of the practitioner is maintained substantially at the level of the base unit, thereby allowing the practitioner to facilitate delivery when the mother gives birth in a standing or upright position.

The present invention relates to apparatus for assisting obstetrics practitioners during the delivery of a baby, and in particular relates to portable chairs for supporting practitioners during standing deliveries.

Obstetrics practitioners, such as midwives and consultants, are required to facilitate delivery of a baby no matter what position a pregnant mother assumes during labour. To minimise pain, some mothers prefer not to be confined to a bed during labour, and instead may choose to walk around the delivery room and/or assume other relaxing positions and postures.

A significant number of pregnant mothers prefer to give birth in an upright or standing position, or else may choose to perch on the edge of a bed or table etc. Although, this may be beneficial to the mother, the practitioner generally has to maintain a low position relative to the ground, so as to monitor and assist with the delivery of the baby. Typically practitioners may have to spend considerable periods of time either sitting on a cold floor, or else kneeling in front of the pregnant mother.

Apart from being uncomfortable for the practitioner, prolonged kneeling and contact with the floor environment may cause long term injury to the practitioner during his/her career, including damage to knee cartilage, possibly leading to osteoarthritic and rheumatic conditions in later life, and generally poor circulation in the practitioner's legs.

Conventional seating, such as static chairs and adjustable computer chairs, do not address the problems of the practitioner, since neither is able to provide seating at a sufficiently low level to the ground. Moreover, conventional seating is typically designed to be non-portable, and especially in the case of computer chairs, can be particularly heavy and cumbersome for a practitioner to easily transport around with them. Hence, it is generally impractical for a practitioner (such as a community midwife) to carry conventional seating with them, when, for instance, assisting with deliveries in a non-hospital environment (e.g. home settings etc.).

A further disadvantage of conventional seating is that it generally includes materials, such as upholstery or leather etc., which cannot be readily disinfected prior to introduction into the delivery environment. Hence, conventional seating may be unhygienic for use by a practitioner, and therefore must be avoided so as to minimise the risk of infection to the mother and/or child.

An object of the present invention is to provide a portable chair which allows an obstetrics practitioner to maintain a low position relative to a floor surface to facilitate child birth during standing deliveries.

A further object of the present invention is to provide a compact, lightweight and hygienic chair which can be readily cleaned and transported between deliveries by a practitioner.

A further object of the present invention is to provide a height adjustable chair having a low profile and which is highly manoeuvrable within a delivery environment.

According to a first aspect of the present invention there is provided a portable chair for an obstetrics practitioner, comprising:
a seat for receiving the posterior of the practitioner;
a height adjustment means for varying the height of the seat above a floor surface; and
a base unit configured to allow translation of the chair in a plurality of directions across the floor surface;
wherein the height adjustment means is adapted for lowering the height of the seat to a first level at which the posterior of the practitioner is maintained substantially at the level of the floor surface.

According to a second aspect of the present invention there is provided a portable chair for an obstetrics practitioner, comprising:
a seat for receiving the posterior of the practitioner;
a height adjustment means for varying the height of the seat above a floor surface; and
a base unit configured to allow translation of the chair in a plurality of directions across the floor surface;
wherein the height adjustment means has a range of operation between a first level and a second level corresponding to at least about three times the height of the first level.

According to a third aspect of the present invention there is provided a portable chair for an obstetrics practitioner, comprising:
a seat for receiving the posterior of the practitioner;
a height adjustment means for varying the height of the seat above a floor surface; and
a base unit configured to allow translation of the chair in a plurality of directions across the floor surface;
wherein the height adjustment means has a range of operation lower than about 45 cm above the floor surface.

Embodiments of the present invention will now be described in detail by way of example and with reference to the accompanying drawings in which:

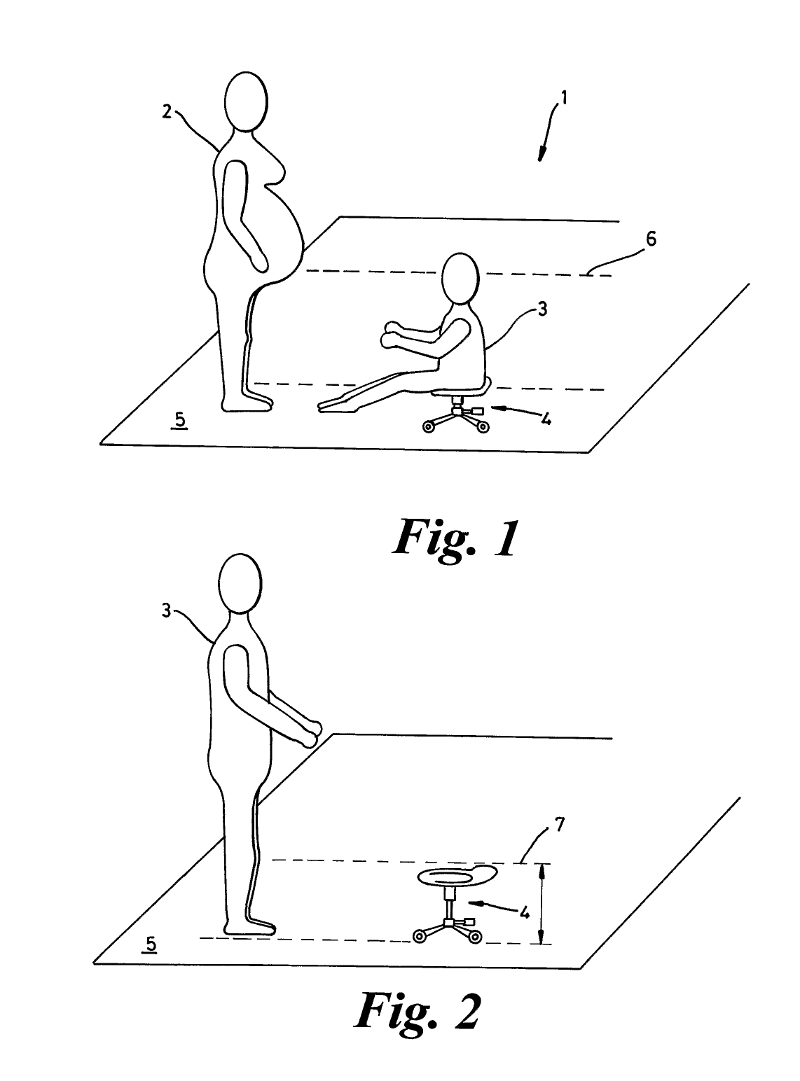

FIG. 1 shows a portable obstetrics chair according to the present invention in use by a practitioner during a standing delivery.

FIG. 2 shows the chair of FIG. 1 alongside a fully standing practitioner of average height.

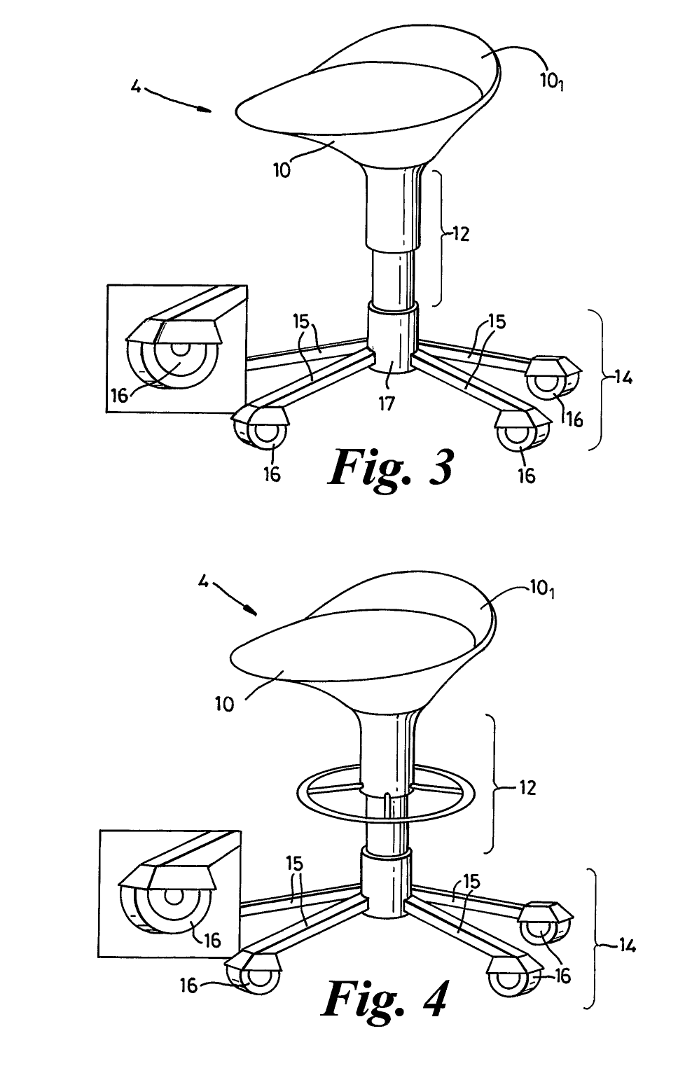

FIG. 3 is a side perspective view of a preferred arrangement of the chair of FIG. 1.

FIG. 4 is a side perspective view of another preferred arrangement of the chair of FIG. 1.

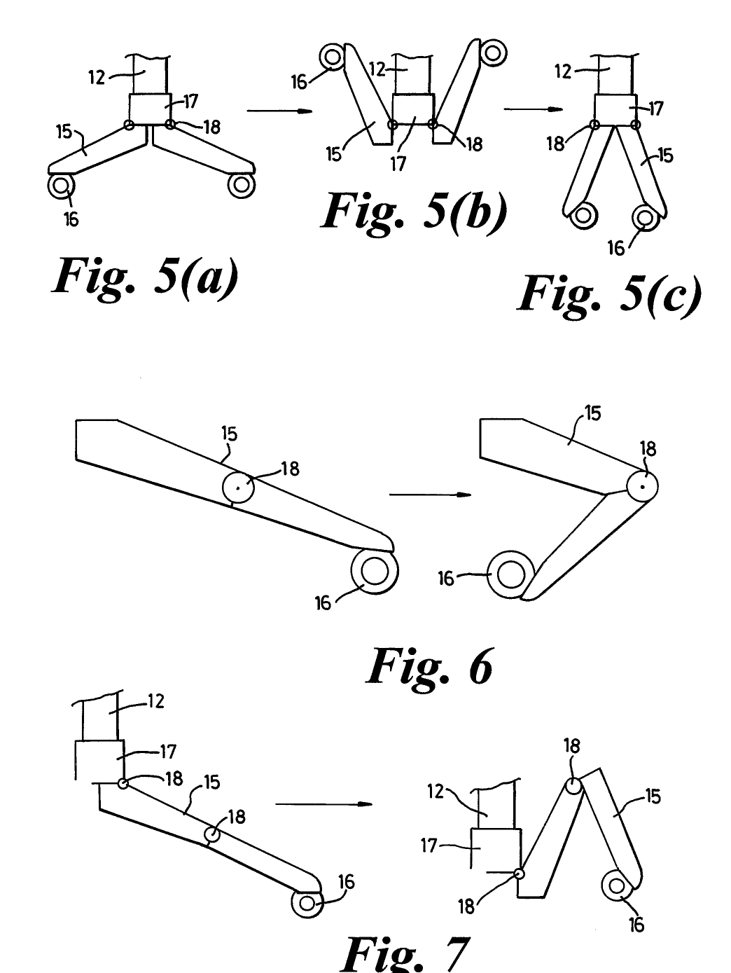

FIG. 5 is a schematic view of a preferred base unit of the chair of FIG. 3 in which (a) chair is in use and (b) and (c) chair is alternatively stowed for storage.

FIG. 6 is a schematic view of a preferred radial spoke of the base unit of FIG. 3, showing preferred deployed and stowed positions.

FIG. 7 is a schematic view of the preferred radial spoke of FIG. 6 attached to a hub of the base unit of FIG. 3, showing preferred deployed and stowed positions.

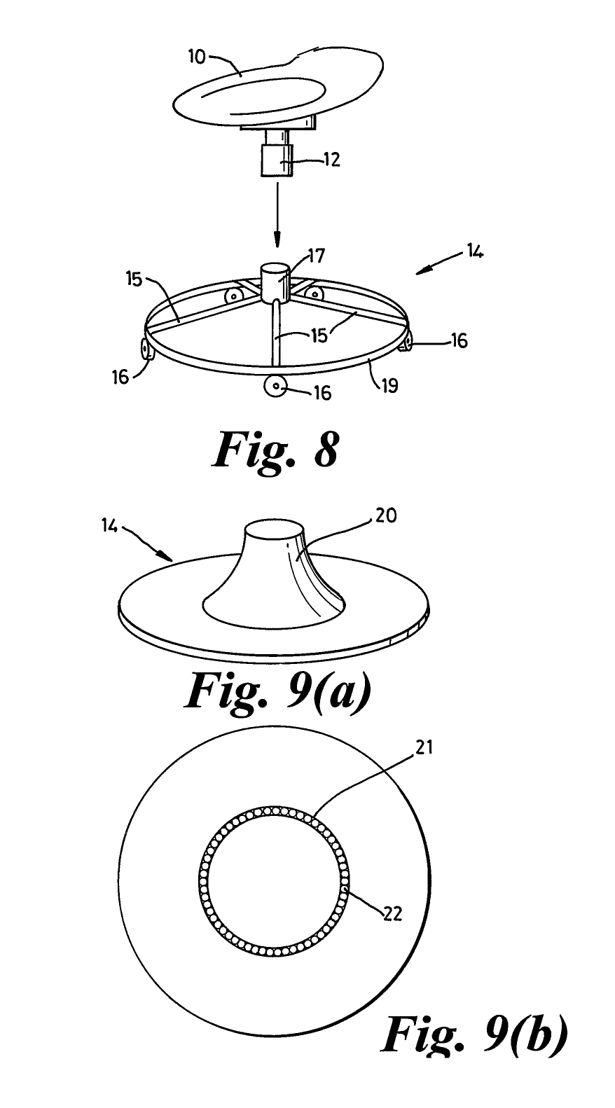

FIG. 8 is a side elevation view of an alternative base unit according to the present invention.

FIG. 9(a) is a side elevation view of an alternative base unit according to the present invention, and (b) is a plan view of the underside of the base unit.

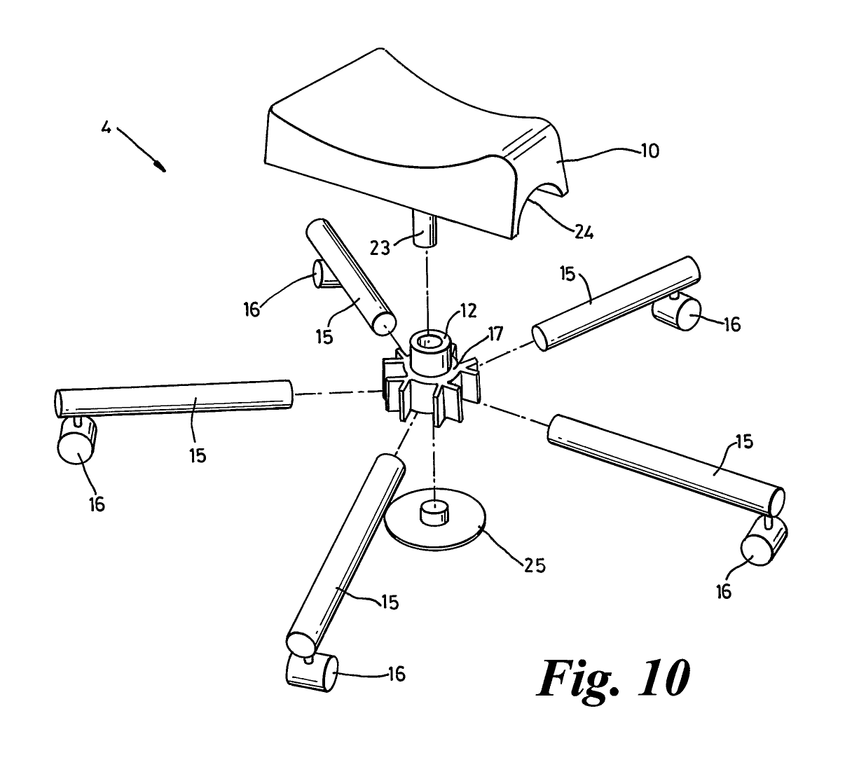

FIG. 10 is an exploded perspective view of an exemplary arrangement of a portable obstetrics chair of the present invention.

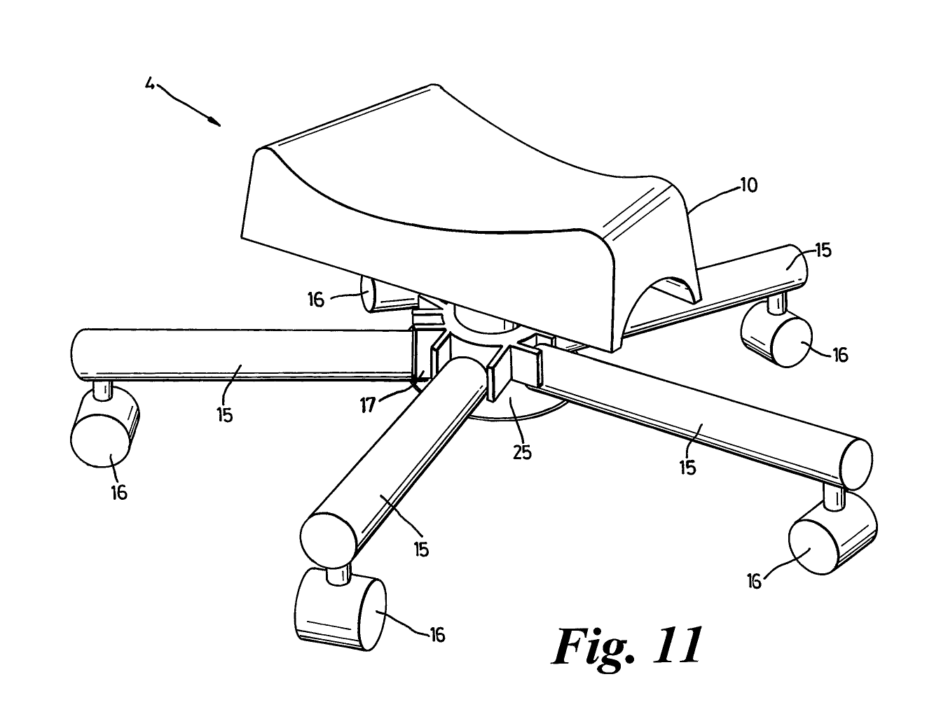

FIG. 11 is a side perspective view of the chair of FIG. 10, shown in a deployed, low height setting.

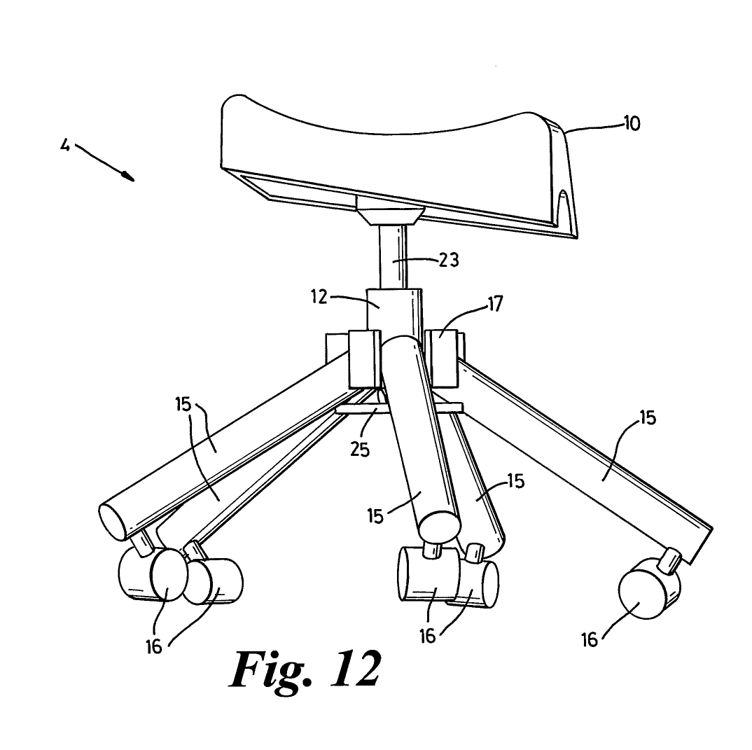

FIG. 12 is a side perspective view of the chair of FIG. 11, shown in a deployed raised height setting.

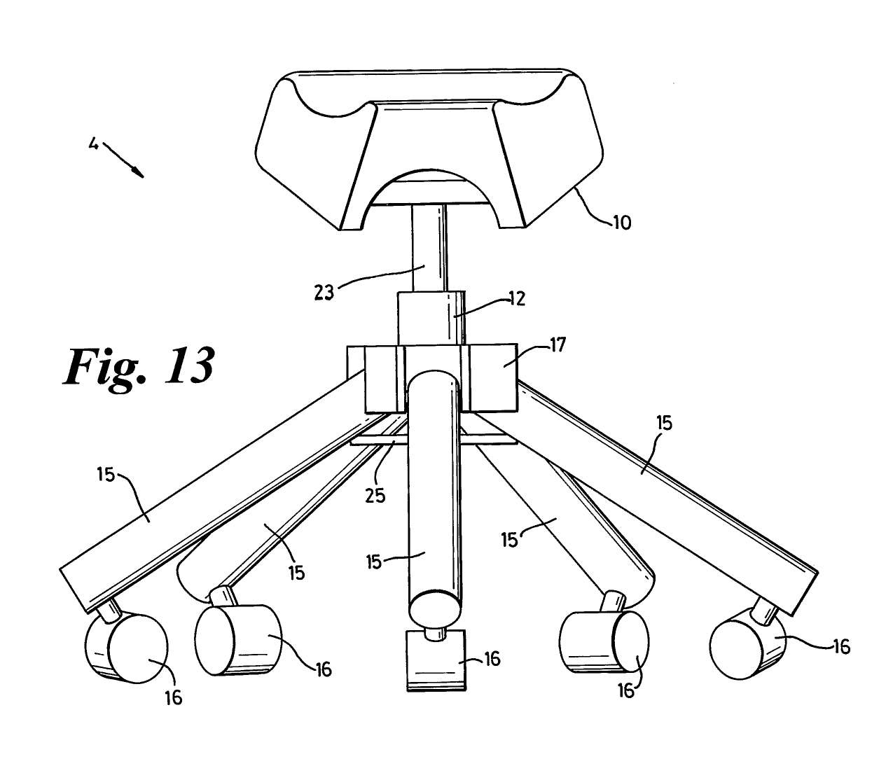

FIG. 13 is a front perspective view of the chair of FIG. 12.

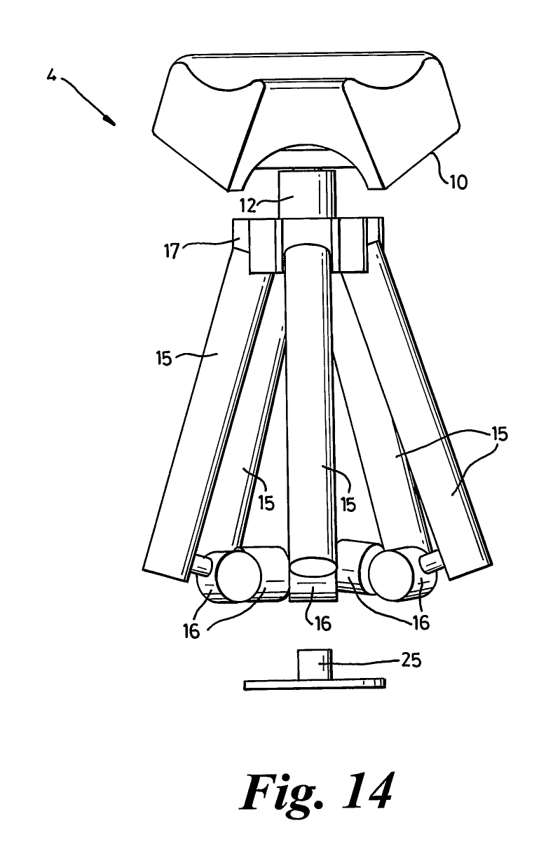

FIG. 14 is a front perspective view of the chair of FIG. 12, shown in a stowed position.

With reference to FIG. 1 there is shown an example delivery environment 1 (e.g. a delivery room of a maternity hospital or a home setting etc.), in which a pregnant mother 2 has assumed a standing position for delivery of her child. Assisting with the delivery is a practitioner 3, who is shown in a seated posture having their posterior (i.e. bottom) on top of a portable chair 4 according to the present invention.

It is to be understood herein that any references to “standing position” or “standing posture” are taken to mean that the pregnant mother 2 has assumed a substantially upright position in order to give birth, or has assumed a (forward/backward facing) perched position against the edge of a bed, desk or table etc.

As is clear from FIG. 1, the chair 4 allows the practitioner 3 to be maintained at a low level relative to the floor surface 5, without having to come into direct contact with the floor environment (other than the soles of his/her feet), and without having to crouch or rest on his/her knees. The chair 4 has a sufficiently low profile (i.e. maximum height dimension) to allow the practitioner 3 to monitor and assist with the delivery of the child at substantially the eye level of the seated practitioner—corresponding to substantially the lower waist region of the pregnant mother 2 (as illustrated by dashed line 6).

Referring to FIG. 2, the maximum height dimension of the chair (shown by dashed line 7 relative to floor surface 5) is shown along side a practitioner 3 of average height for illustrative comparison. It should be appreciated however, that the scale of FIG. 2 is not intended to be limiting, and that the height and dimensions of the chair 4 may be varied in accordance with the following preferred arrangements.

In a preferred arrangement of the present invention, as shown in FIG. 3, the chair 4 comprises a seat 10 to receive the posterior of the practitioner 3, a height adjustment means 12 to vary the height of the seat 10 above the floor surface 5 of the delivery environment 1 and a base unit 14 to allow the chair 4 to be translated in a plurality of directions across the floor surface 5.

The seat 10 is preferably moulded as a single element from any plastic suitable for medical use or use in sterile environments, provided the plastic is resilient to disinfecting agents and cleaners. To reduce weight further, the seat 10 may also be perforated across all of its surface, or else localised regions of the surface (not shown). Alternatively, the seat 10 may be fabricated from a suitable sheet metal, such as aluminium or thin steel, which again may be perforated to reduce weight.

In another arrangement, a sheet metal seat may be coated with a thin layer of plastic or rubber which is suitable for sterile use.

Preferably the seat 10 is substantially saddle shape in form (as shown in FIG. 10), so as to provide a contoured surface for improved comfort of the practitioner 3. Alternatively, as shown in FIGS. 3 and 4, the seat 10 may be substantially circular in form and may have a slightly concave seating portion to receive the posterior of the practitioner 3. In some arrangements, as illustrated in FIG. 3, the seat 10 may also include a lower back rest or support 101, which protrudes above the plane of the seating portion and provides additional comfort for the practitioner 3 while waiting during prolonged periods of labour.

The lower back rest 10₁ may be integral to the seat 10, forming part of the mould from which the seat 10 is fabricated. Alternatively, the lower back rest 10₁ may be a separate component that is permanently attached to the seat 10 using any suitable form of attachment means, such as screws, heat bonding agents or adhesives etc. In these arrangements, the lower back rest 10₁ may include a handle (not shown), either attached to the rest or else formed as part of the rest e.g. a hand slot etc., to aid portability of the chair 4.

In other arrangements, the lower back rest 10₁ may be detachably connected to the seat 10 by any suitable means, e.g. clips, pins or slotted arrangements. In this way, the lower back rest 10₁ may be removed to allow the chair 4 to be stowed for subsequent storage and/or transport.

However, it is to be appreciated that the seat 10 may have any suitable shape or form, and can be either planar or contoured, provided the shape allows easy cleaning and appropriate comfort during prolonged periods of labour. Hence, in all preferred arrangements the seat 10 is essentially free of any surface features which are likely to attract dirt, grime and germs and/or impede cleaning of the chair.

To assist with the portability of the chair 4, the seat 10 can be detachably connected to the height adjustment means 12, using any suitable attachment means, such as clips, a locking screw or a bayonet fitting etc. Therefore, the seat 10 may be removed from the height adjustment means 12 when the chair 4 is to be stowed for storage or transportation. Advantageously, this functionality also allows the seat 10 to be more easily cleaned and disinfected after use.

In alternative arrangements, the seat 10 may be pivotally connected to the height adjustment means 12 via a suitable hinge, to allow the seat 10 to be placed in a stowed position for storage and/or transportation. For example, the “stowed position” would be arrived at by tilting the seat 10 so that the plane of the seating portion is substantially parallel to the longitudinal axis of the height adjustment means 12 (not shown).

In preferred arrangements, the seat 10 is mounted to the height adjustment means 12 for 360 degree continuous rotation about the seat's axis of rotation. This allows the practitioner 3 to swivel in either direction while remaining seated on the chair 4, thereby permitting the practitioner 3 to locate equipment/medical supplies etc. situated peripherally around his/her location. The ability to swivel on the chair 4 also allows the practitioner 3 to track small lateral movements of the mother during labour and delivery, without having to leave the seat 10.

The seat 10 may be mounted to the height adjustment means 12 via a mounting head which allows the seat to be tilted through a plurality of degrees of freedom, relative to the base unit 14. The mounting head may be any suitable device, such as a ball and socket etc., which permits the seat to be releasably locked in a plurality of tilted arrangements. This feature provides further comfort for the practitioner 3, as the seat may be oriented into the most appropriate position for monitoring and facilitating delivery of the child.

The height adjustment means 12 is adapted to vary the height of the seat 10 above the floor surface 5 of the delivery environment 1. Herein, the “height of the seat” may correspond to the level of the upper surface, or seating portion (or major part thereof) of the seat 10 as measured from the floor surface 5. So as to position the practitioner 3 at the appropriate height to facilitate delivery when the mother is in a standing position (see FIG. 1), the height adjustment means 12 can lower the seat 10 to a minimum height level at which the posterior of the practitioner 3 is substantially at the level of the base unit 14. In this way, the practitioner 3 is maintained at a low level relative to the floor surface (see FIG. 1). The height adjustment means 12 has a range of operation which allows the height of the seat 10 to be varied between the minimum height level and a maximum height level, greater than the minimum height level. In preferred arrangements, the maximum height level corresponds to about 3 times the height of the minimum height level. In other preferred arrangements, the maximum height level may correspond to about 4 or 5 times the height of the minimum height level.

Preferably, the minimum height level is about 15 cm above the floor surface 5 of the delivery environment 1, and therefore in preferred arrangements the maximum height level is about 45 cm above the floor surface 5. It is to be appreciated that this range of operation is not intended to be limiting, and the minimum height level may be less than 15 cm, depending on the maximum height dimension of the base unit 14.

The minimum height level will also depend on the minimum height dimension of the height adjustment means 12, and therefore the height adjustment means 12 must have a minimum height dimension that is less than or equal to the minimum height level. In preferred arrangements, the height adjustment means 12 is adapted to retract substantially into the base unit 14 when the seat 10 is lowered to the minimum height level.

Preferably, the height adjustment means 12 is a telescoping pneumatic pedestal, of the form used in conventional adjustable computer chairs, which is adapted to have a low profile when retracted to its minimum height dimension. The pedestal is preferably made from metal, such as tubular steel, and may contain two or more telescoping sections, depending on the desired maximum height level of the seat 10. The pedestal must have sufficient structural strength to support the weight of a practitioner 3, when retracted and extended to its maximum height.

The telescoping pneumatic pedestal is preferably operated using a suitable lever, in the conventional manner, connected to a section of the pedestal, or alternatively to the underside of the seat 10 or mounting head etc.

In alternative arrangements, the height adjustment means 12 may be a hydraulic based telescoping pedestal or a rack and pinion shaft assembly. In the latter arrangement, the height of the seat 10 would be varied by turning a suitable form of crank, such that one direction of rotation would increase the height and a counter direction of rotation would decrease the height.

In another arrangement, the height adjustment means 12 may be in the form of a short threaded barrel of fixed length, adapted to receive a reciprocally threaded stem attached to the underside of the seat 10. The height of the seat 10 would be varied by turning the seat 10 such that the stem travels upwardly and downwardly through the length of the barrel.

In a further arrangement, the height adjustment means 12 may be a short barrel having a plurality of periodically spaced hole pairings, diametrically opposed across the width of the barrel. The barrel receives a stem attached to the underside of the seat 10, the stem having a corresponding pattern of periodically spaced hole pairings. The practitioner 3 adjusts the height of the seat 10 by sliding the stem through the barrel until a set of holes in the stem match a set of holes in the barrel at an appropriate height, whereupon the practitioner 3 inserts a pin through the aligned sets of holes.

It is to be appreciated that any suitable means of varying the height of the seat 10 may be used, provided that the seat 10 can be lowered to a minimum height level at which the posterior of the practitioner 3 is maintained substantially at the level of the floor surface 5, thereby positioning the practitioner 3 at a low level with respect to the pregnant mother 2.

By “substantially at the level of the floor surface” we mean that the posterior of the practitioner 3 is supported in close proximity to the floor surface 5, typically below a height of about 45 cm from the floor surface, and most preferably below a height of about 30 cm. Such a height level is clearly below the typical height provided by conventional computer chairs and seating, which operate at height levels consistent with the vertical extent of desks and tables etc. (e.g. about 60-80 cm high) and thus do not achieve height levels which are in close proximity to the floor surface.

The base unit 14 has a low maximum height dimension, so as to reduce the overall height of the chair 4. Preferably, in order to position the practitioner 3 at an appropriate height to facilitate standing deliveries, the base unit 14 has a maximum height dimension of about 15 cm. It is to be appreciated however, that this is not intended to be limiting, and the maximum height dimension may be less than or more than 15 cm, depending on the desired overall height of the chair 4.

In the preferred arrangement of FIG. 3, the base unit 14 includes a support frame having 5 sets of casters 16 mounted on radial spokes 15. The support frame is preferably made from a hard plastic which is suitable for medical and sterile environment use. In preferred arrangements, the support frame may include a central hub 17 from which the radial spokes 15 extend outwardly. The hub 17 and spokes 15 may be integrally moulded as a single unit, or else formed as separate connectable components.

In preferred arrangements, the spokes 15 are detachably connected to the hub 17 permitting the practitioner 3 to remove the spokes 15 when the chair 4 is to be stowed for storage and/or transport. The spokes 15 may be attached to the hub 17 using any suitable attachment means, such as, but not limited to, threaded screws or a slot arrangement.

In alternative preferred arrangements, as shown in FIG. 5(a) to (c), the spokes 15 may be pivotally connected to the hub 17 using a suitable hinge or hinge joint 18, to allow the spokes 15 to be folded into a stowed position when the chair 4 is no longer in use or is to be transported. In FIG. 5(b), the spokes 15 are retracted upwardly towards the height adjustment means 12, while in FIG. 5(c), the spokes 15 are retracted downwardly away from the height adjustment means 12. The base unit 14 could be adapted to permit only one of these configurations to be adopted in any given chair 4, or else the chair 4 may be modified to allow either configuration to be adopted by the practitioner 3, depending on the particular hinge joint 18 used.

The ability to detach or fold the spokes 15 of the base unit 14, provides the advantage of increasing the portability of the chair 4, thereby allowing the practitioner 3 to readily transport the chair 4 between different delivery environments 1.

To further increase the portability of the chair 4, each radial spoke 15 may include one or more hinge joints 18 along its length, as shown in FIGS. 6 and 7. A hinge joint 18 in the spoke 15 allows the spoke 15 to be folded in the manner illustrated by FIG. 6, thereby reducing the overall size of the chair 4 when the chair is no longer in use.

Referring to FIG. 7, if the spoke 15 is also pivotally connected to the hub 17, the spoke 15 can be further folded towards the height adjustment means 12, providing additional space saving functionality for the practitioner 3 when stowing the chair 4 for storage and/or transportation.

The casters 16 in base unit 14 are conventional types, either plastic or metal, comprising either a single wheel or a pair of wheels as desired. Herein, any reference to “caster” or “casters” is to be taken as meaning both single, paired and multi- wheel configurations.

The casters 16 are preferably attached to the respective distal ends of the radial spokes 15, as shown in FIG. 3, using a suitable mounting bracket or attachment mechanism. The casters 16 are configured for 360 degree continuous rotation about their respective points of attachment. The free rotation of the casters 16 allows the chair 4 to be translated in a plurality of directions across the floor surface 5 of the delivery environment 1. This gives the chair 4, and practitioner 3, a high degree of manoeuvrability around and about the pregnant mother 2.

Although the support frame is shown with 5 radial spokes 15 (note one is obscured by the pedestal), it is to be appreciated that the support frame may include 3 or more radial spokes 15 as desired. A higher number of spokes 15 increases stability for the practitioner 3, but also increases the overall weight of the chair 4. Therefore, a balance must be made between stability and portability. In the present invention, 5 radial spokes 15 has been found to provide adequate stability, while enabling ease of transportation.

In preferred arrangements, the base unit 14 includes a releasable locking mechanism to prevent translation of the chair 4. This functionality is important as it allows the practitioner 3 to maintain a “braced” position by virtue of the locking mechanism, when the pregnant mother 2 is holding onto, or pushing against, the practitioner during delivery.

In the arrangement of FIG. 3, the locking mechanism is in the form of a releasable brake disposed at the distal end of at least one of the radial spokes 15 (see inset). The brake is configured to engage with a corresponding caster 16 when the practitioner 3 applies force to the brake, e.g. by pressing the brake with the sole of his/her foot. In other arrangements, the locking mechanism may be configured to centrally lock, such that all casters 16 are locked when at least one releasable brake is operated.

Alternatively, one or more of the spokes 15 may include a spring loaded pin (not shown), having a rubber bung-like tip, which passes through the body of the spoke 15 at a convenient location along its length. When the practitioner 3 desires to prevent translation of the chair 4, he/she presses down on the pin (e.g. by using the sole of his/her foot), so that the tip engages with the floor surface 5. The friction between the tip and the floor increases the chair's resistance to motion, thereby restricting the translation of the chair 4. The pin can be locked in position and then subsequently released when translation of the chair 4 is again desired.

It is to be appreciated that any suitable form of releasable locking mechanism may be used to prevent the chair 4 from moving. Moreover, the chair 4 may also include a swivel lock to prevent the seat 10 from rotating.

To increase portability of the chair 4, the base unit 14 may preferably be detachably connected to the height adjustment means 12. Hence, in some arrangements, each of the seat 10, height adjustment means 12 and base unit 14, may be separately detached from each other for storage and transportation.

In arrangements in which the base unit 14 is detachable, the base unit 14 is adapted to have a portion for receiving and attaching the height adjustment means 12. In the particularly preferred arrangement of FIG. 3, the central hub 17 of the support frame is designed to receive the height adjustment means 12 when the chair 4 is assembled for use. The height adjustment means 12 may attach to the base unit 14 using any suitable means, such as, but not limited to, a friction fit, a bayonet fitting, threaded screw or locking screw.

Referring to FIGS. 8 and 9, there are shown alternative arrangements for the base unit 14 of the present invention. The base unit 14 may include a support frame having an outer circular hoop 19 connected to a central hub 17 by a plurality of radial spokes 15 (see FIG. 8). The hoop 19 serves to increase the structural strength of the support frame, and permits the thicknesses of the spokes 15 to be accordingly reduced, thereby saving weight. The base unit 14 shown in FIG. 8 may be made from hard plastic or tubular metal, the latter alternatively being covered by thin plastic or rubber of a type suitable for use in sterile environments. A plurality of casters 16 may be attached at periodic angular positions around the hoop 19, either at the junctions of the spokes and hoop, or at both the junctions and locations therebetween.

The central hub 17 of the support frame is adapted to receive the height adjustment means 12, as described in relation to previous arrangements. The support frame of FIG. 8 is intended to be fabricated as a single, non-collapsible component having a maximum height dimension of less than or equal to about 15 cm.

In FIG. 9, there is shown an alternative arrangement in which the base unit 14 is formed as a single integrally moulded component, preferably made of hard plastic of a type for use in sterile environments. The base unit 14 is generally conical in shape (see FIG. 9(a)), having a neck portion 20 dimensioned to receive the height adjustment means 12. The base unit 14 can be detachably connected to the height adjustment means 12, allowing the practitioner 3 to remove the base unit 14 when the chair 4 is to be stowed for storage and/or transportation.

In FIG. 9(b), the underside of the base unit 14 is shown according to a preferred arrangement. The bottom surface of the base unit 14 is preferably substantially flat and includes a circular channel 21, either machined into the surface or else formed during moulding of the base unit.

The channel 21 is adapted to contain a plurality of spherical bearings 22, made from either hardened plastic or preferably metal, which partly extend outside of the channel 21. The circular arrangement of bearings engages with the floor surface 5 of the delivery environment 1 when the chair 4 is placed on the floor, and serves as a multi-directional and substantially frictionless translation mechanism.

The spherical bearings 22 typically have a diameter of about 1-3 cm, depending on the depth and width of the channel 21. The circular channel 21 may be located at any suitable radial distance from the centre of the base unit 14, provided adequate stability of the chair 4 is accomplished for the practitioner 3. In a preferred arrangement, the bearings 22 may be located substantially towards the outer periphery of the base unit 14.

It is to be appreciated that any suitable form of base unit 14 may be used in the chair 4 of the present invention, provided it is able to impart sufficient manoeuvrability and ease of cleaning.

The portable chair 4 of the present invention may be adapted to include additional features and modifications, including a foot or ankle rest coupled to either the height adjustment means 12 or the base unit 14, as illustrated in FIG. 4. This could be circular in form or else comprise one or more arcuate sections located around the periphery of the height adjustment means 12 or base unit 14.

To aid portability, the seat 10 may be moulded to include a handle on its underside or else include a hand slot in the region of the seating portion, enabling the practitioner 3 to easily pick up the chair 4 during and after use.

The chair 4 may also be adapted to include one or more conventional drive motors coupled to the height adjustment means 12 and connected to a cable or remote control device, which allow the practitioner 3 to adjust the height of the seat 10 automatically, or to set the chair 4 into an automatic or default stowed mode for storage and/or transportation.

The present invention also provides for a carrying device for the portable obstetrics chair as described in the foregoing arrangements. The carrying device preferably comprises a handle and a case having at least one compartment to receive the portable chair 4, the chair 4 either being in a stowed position, dismantled or fully assembled when in the compartment.

Referring to FIG. 10, there is shown in exploded view an exemplary arrangement of the portable chair 4 of the present invention. Like components are numbered in accordance with previous arrangements. As discussed earlier, the seat 10 is preferably in the form of a saddle, having a contoured surface to improve comfort for the practitioner during prolonged periods of the pregnant mother's labour. The seat 10 may either be detachably connected (for ease of storage and transportation), or permanently attached to, the height adjustment means 12, via central column 23.

To assist with ease of transportation, the front of the seat 10 may be shaped to include a recessed portion 24, which permits the practitioner s hand to firmly grasp the seat 10 for easy and convenient lifting of the chair 4.

Of course, the recessed portion 24 may be located on any suitable face of the seat 10, and as previously discussed, could alternatively be an integral handle or slot.

In the exemplary arrangement of FIG. 10, there are 5 radial spokes 15, each of which are pivotally connected to the central hub 17 using any suitable hinge device or mechanism. The pivotal connections permit the spokes 15 to be positioned at any appropriate angle with respect to the longitudinal axis of the chair 4, i.e. the axis substantially normal to the plane of the seat 10. The radial spokes 15 are preferably made from tubular steel or aluminium to reduce the overall weight of the chair. Each spoke 15 terminates in a respective caster 16 which permits the chair 4 to be translated in a plurality of directions in and about the delivery environment 1.

As illustrated in FIG. 11, the chair 4 is shown in a preferred deployed arrangement, in which the spokes 15 have been locked in a substantially horizontal orientation. In this exemplary arrangement, the hinges on the central hub 17 are configured to allow the spokes 15 to lock substantially parallel to the plane of the floor surface 5, thereby enabling the lowest possible height profile to be achieved for the base unit 14. Preferably, the hinges are locked by the action of a circular locking plate or collar 25 (best shown in FIG. 10), which is threaded, or releasably snap fitted, into the base of the central hub 17, thereby preventing the spokes 15 from pivoting further and hence locking the spokes 15 into position. In this way, the seat 10 is maintained substantially at the level of the floor surface 5 and the height profile of the chair 4 is thereby minimised.

In alternative arrangements, the hinges may themselves be individually lockable, by way of a pin, latch or ratchet etc. and therefore the locking plate 25 need not be used to lock the spokes 15 into position in these embodiments.

A possible modification to the exemplary chair arrangement of FIG. 11 is shown in FIG. 12, which is also consistent with all the other preceding arrangements of the present invention as described herein. The hinges of the central hub 17, may be made to be lockable into a plurality of intermediate positions, so that the spokes 15 may be deployed at varying angles with respect to the normal axis passing through the plane of the seat 10. Preferably, this may be best achieved by having the circular locking plate 25 threaded into the base of the central hub 17, which when advanced or retracted along the thread of the central hub 17 would automatically vary the angle of the spokes 15 relative to the normal axis of the seat 10. In this way, further height adjustments may be achieved which complement the height variability provided by the height adjustment means 12. Therefore, a greater range of height variation of the seat 10 may be obtained by altering the angle at which the spokes 15 are deployed.

In alternative arrangements, the seat 10 may be fitted directly to the central hub 17 and the height of the seat 10 may be adjusted directly by varying the angle of the deployed spokes 15, in this way, the height adjustment means would correspond to the hinges and locking plate 25, and therefore would form part of the base unit 14, with no separate pneumatic pedestal etc. being required in such embodiments.

However, in the exemplary arrangement as shown in FIG. 13, both a pneumatic pedestal 12 and locking plate 25 are fitted in combination, permitting a greater control over the height of the seat 10 of the chair 4 relative to the floor surface 5.

It is to be understood that in all arrangements in which the spokes 15 are deployed at varying angles with respect to the normal to the seat 10, the casters 16 are configured to lockably pivot, so that they can be set at an appropriate angle with respect to the floor surface 5, to thereby enable easy translation across the floor surface 5 and provide sufficient load bearing capabilities for the chair 4.

Referring to FIG. 14, the chair 4 of the exemplary arrangement is shown in a stowed arrangement for storage or transportation, with the locking plate 25 removed and the spokes 15 folded towards each other so as to minimise the lateral extent of the chair 4 (i.e. the footprint of the base unit 14) when not in use. It is to be appreciated in FIG. 14, that the casters 16 could be configured so as to be substantially alignable along the longitudinal axis of the respective spoke 15, so as to permit further space saving during storage etc.

Although the portable chair of the present invention is ideal for assisting a practitioner during delivery of a child, it will be recognised that one or more of the principles can extend to other applications, including agricultural, such as dairy farming, ground level mechanical work (e.g. car body repair) and veterinary purposes, and any other application were individuals need to be maintained in a seated posture close to the ground or floor surface.

Other embodiments are taken to be within the scope of the accompanying claims.

1. A portable chair for an obstetrics practitioner, comprising:
a seat for receiving the posterior of the practitioner;
a height adjustment means for varying the height of the seat above a floor surface; and
a base unit coupled to the height adjustment means and configured to allow translation of the chair in a plurality of directions across the floor surface;
wherein the height adjustment means is adapted to lower the height of the seat to a first level at which the posterior of the practitioner is substantially at the level of the base unit.

2. The portable chair of claim 1, wherein the height adjustment means has a range of operation between the first level and a second level corresponding to at least about three times the height of the first level.

3. The portable chair of claim 2, wherein the range of operation is between about 15 cm to about 45 cm.

4. The portable chair of claim 4, wherein the base unit has a maximum height dimension of about 15 cm.

5. The portable chair of claim 1, wherein the base unit includes a releasable looking mechanism to prevent translation of the chair across the floor.

6. (canceled)

7. The portable chair of claim 5, wherein the base unit comprises:
at least three casters; and
a support frame.

8. The portable chair of claim 7, wherein the support frame includes a central hub and a radial spoke for each caster, each radial spoke attached at its proximal end to the hub and adapted to receive a caster at its distal end.

9-14. (canceled)

15. The portable chair of claim 8, wherein the seat is detachably connected to the height adjustment means.

16. The portable chair of claim 1, wherein the seat is pivotally connected to the height adjustment means to allow the seat to be placed in a stowed position for storage.

17. The portable chair of claim 16, wherein the seat is mounted to the height adjustment means for 360 degree continuous rotation about its axis of rotation.

18. The portable chair of claim 17, wherein the seat is mounted to the height adjustment means via a mounting head which allows the seat to be tilted through a plurality of degrees of freedom, relative to the base unit.

19. The portable chair of claim 18, wherein the height adjustment means is a telescoping pneumatic pedestal.

20-23. (canceled)

24. A portable chair for an obstetrics practitioner, comprising:
a seat for receiving the posterior of the practitioner;
a height adjustment means for varying the height of the seat above a floor surface; and
a base unit with the height adjustment means and configured to allow translation of the chair in a plurality of directions across the floor surface;
wherein the height adjustment means has a range of operation between a first level and a second level corresponding to at least about three times the height of the first level.

25. A portable chair for an obstetrics practitioner, comprising:
a seat for receiving the posterior of the practitioner;
a height adjustment means for varying the height of the seat above a floor surface; and
a base unit coupled to with the height adjustment means and configured to allow translation of the chair in a plurality of directions across the floor surface;
wherein the height adjustment means has a range of operation lower than about 45 cm above the floor surface.

26. The portable chair of claim 24, wherein the height adjustment means forms part of the base unit.

27. The portable chair of claim 24, wherein the height adjustment means is configured to adjust the height dimension of the base unit, thereby varying the height of the seat above the floor surface.

28. A portable chair for an obstetrics practitioner, comprising:
a seat for receiving the posterior of the practitioner; and
a base unit including a plurality of radial members, each radial member being positionable at an angle relative to an axis normal to the plane of the seat, to thereby permit the height of the seat to be varied as a function of the angular displacement of the radial members relative to the axis of the seat.

29-30. (canceled)
